(19) United States
(12) Patent Application Publication
(10) Pub. No.: US 2022/0028196 A1
(43) Pub. Date: Jan. 27, 2022

(54) METHOD AND SYSTEM FOR MONITORING PORTABLE ARTICLES

(71) Applicant: Se-Kure Controls, Inc., Franklin Park, IL (US)

(72) Inventors: David M. Adams, Stone Park, IL (US); James F. Dryden, Hawthorn Woods, IL (US); Laura A. Greenwell, Bristol, WI (US); John V. Mangiameli, Hawthorn Woods, IL (US); David L. Wooden, Northlake, IL (US); Patrick C. Panico, Berwyn, IL (US); John W. Manser, Elgin, IL (US); Jorge L. Meza, Westchester, IL (US)

(21) Appl. No.: 17/089,948

(22) Filed: Nov. 5, 2020

Related U.S. Application Data
(60) Provisional application No. 63/054,899, filed on Jul. 22, 2020.

(51) Int. Cl. G07C 9/00

(52) U.S. Cl. CPC G07C 9/00817

(57) ABSTRACT

A method of, and system for, handling a portable article. The method includes the step of delivering the portable article to a destination site at which the portable article is operatively associated with an alarm device. The alarm device has an activated mode and a deactivated mode. With the portable article operatively associated with the alarm device at the destination site and the alarm device in the activated mode, the alarm device generates an alarm signal in the event an unauthorized activity with respect to the portable article occurs.

### BACKGROUND OF THE INVENTION

### Field of the Invention

This invention relates to portable articles and, more particularly, to a method and system for monitoring unauthorized tampering therewith at sites to which the portable articles are delivered.

### Background Art

There is a continuously evolving commerce model of home and business delivery with products ranging from inexpensive grocery items to very expensive items, such as sophisticated electronics. A challenge to purveyors across most product categories has been to offer competitive prices with the fastest delivery times. Consumers are in fact often willing to pay more for promptly delivered goods.

It is common to see advertisements for next-day or even same-day delivery. Industries are experimenting with drone delivery to reduce delivery times even further.

This exploding delivery model has led to having very large volumes of delivered items placed at the steps and doors of homes and businesses. To increase efficiency, a large percentage of such deliveries are made without any attempt to contact the receiving individuals at the destination addresses. Instead, email follow-ups, often sent well after packages are dropped off, have been used to confirm deliveries.

As a result, it is common to see one or more packages placed outside at doorsteps of a large percentage of homes in any given neighborhood. Individuals may not be aware that a package has been delivered for several hours, even if they are present at the delivery location. The packages may remain unattended on doorsteps for an entire day, as when persons residing thereat are at work or otherwise occupied away from home. Still further, when persons leave their residence or business for several days, as on vacation, it may not be possible to coordinate package delivery to avoid having unattended packages reside visibly outside for multiple days. To many, the only solution is to engage neighbors to monitor for packages in the absence of the recipient.

Accordingly, this model has led to a growing industry for thieves. Persons can scour a neighborhood, or business development, and rapidly accumulate packages which are visibly placed in front of buildings and which are completely vulnerable to being taken, potentially without any detection.

Cameras offer some degree of protection. However, often it is impossible to identify thieves and/or any vehicle they may use during a theft. Even if identification is made, it is often impractical to pursue thieves over stolen merchandise that is not particularly expensive. Recipients are often afforded the insurance of having the shipping entity send a replacement in the event that the intended recipient identifies a failed delivery.

Containers are currently available which allow packages of certain limited size to be placed therein whereby they can be recovered only by authorized persons, as through the use of an access key or code. This approach is limited in the sense that only a limited size of package can be accommodated and also by the fact that a larger container compromises the aesthetics of the surrounding area, which is particularly undesirable in a residential setting.

To this point, the main safeguard in this model has been the willingness of the shipping entities to provide replacement for stolen articles. As a result, many businesses are suffering significant losses which ultimately reflect in future prices paid by consumers.

However, even if a consumer is “made whole” by a replacement, the growing culture of thievery tends to taint the overall security of residential and business neighborhoods and continues the upward thievery trend.

The industry continues to seek viable solutions to the above problems which are practical, reasonably inexpensive, and effective in terms of eliminating a large percentage of this type of activity.

### SUMMARY OF THE INVENTION

In one form, the invention is directed to a method of handling a portable article, the method comprising the steps of: delivering the portable article to a destination site at which the portable article is operatively associated with an alarm device and storing an unlock code, operatively placing the alarm device into an activated mode, providing the unlock code to a recipient of the portable article, and with the portable article operatively associated with the alarm device at the destination site and the alarm device in the activated mode, the alarm device generates an alarm signal in the event an unauthorized activity with respect to the portable article occurs and the alarm device transitioning to a deactivated mode responsive to receiving the unlock code from the recipient of the portable article.

In another form, the invention is directed to an alarm device for monitoring delivery of a portable article to a destination site. The alarm device comprises a housing adapted to be associated with a portable article, the housing enclosing a programmable controller unit configured for wireless communications, a sensor and an alarm generator, and having a unique ID. The programmable controller unit is programmed to: receive and store an unlock code using wireless communications, receive a command to place the alarm device into an activated mode using wireless communications, and with the portable article operatively associated with the alarm device at the destination site and the alarm device in the activated mode, the alarm device activating the alarm generator in the event an unauthorized activity with respect to the portable article occurs as determined by the sensor and the alarm device transitioning to a deactivated mode responsive to receiving the unlock code from the recipient of the portable article using wireless communications.

In still another form, the invention is directed to a system for monitoring delivery of a portable article to a destination site. The system comprises an an alarm device adapted to be associated with a portable article. The alarm device includes a programmable controller unit configured for wireless communications, a sensor and an alarm generator, and having a unique ID. A first smart device generates an unlock code and has wireless communications for transmitting the unlock code to the alarm device. A second smart device has wireless communications and is responsive to delivery of the portable article to a destination site to operatively place the alarm device into an activated mode. A third smart device has wireless communications and selectively receives the unlock code. The programmable controller unit is programmed to: receive and store the unlock code from the first smart device, receive a command to place the alarm device into the activated mode from the second smart device, and with the portable article operatively associated with the alarm device at the destination site and the alarm device in the activated mode, the alarm device activating the alarm generator in the event an unauthorized activity with respect to the portable article occurs as determined by the sensor and the alarm device transitioning to a deactivated mode responsive to receiving the unlock code from the recipient of the portable article using the third smart device.

### BRIEF DESCRIPTION OF THE DRAWINGS

FIG. 1 is a perspective view of a package enclosing a portable article to be monitored and having an alarm device in accordance with the invention;

FIG. 2 is a perspective view illustrating the package of FIG. 1 with the alarm device being selectively activated by a delivery driver and subsequently deactivated by a user;

FIG. 3 is a block diagram of the alarm device of FIG. 1;

FIG. 4 is a schematic representation of the environment of use showing various smart devices interacting with the alarm device of FIG. 1; and

FIG. 5 is a flow diagram illustrating use of the alarm device in the environment of FIG. 4 for monitoring delivery of a package.

### DETAILED DESCRIPTION OF THE PREFERRED EMBODIMENT

The present invention is directed to the handling of portable articles that are delivered to a purchaser. The primary objective of the invention is to control theft of articles commonly transported to, and left at the outside of, a building or another drop-off location, at a destination site. “Portable” is intended to encompass articles that can be relatively easily lifted and moved by one or more persons.

The principle focus of the invention is on previously purchased/ordered articles that are delivered, by a purveyor or a shipper authorized by a purveyor, to a site designated by a purchaser. Per the Background discussion above, the focus is on deliveries made whereby articles are placed in plain view and without any structure confining them at respective sites. As just examples, groceries are commonly purchased and delivered to doorsteps of residences and businesses. Virtually all other types of consumables in portable form are capable of being transported to, and dropped off, at locations where the articles are vulnerable, generally by residing at an exterior location where no persons are physically present, or available, to protect against, or observe, theft. Use at any site where there is no, or low, traffic flow or activity is contemplated.

According to the invention, an alarm device is utilized. The portable article is in different ways operatively associated with the alarm device. The alarm device has an armed or activated state and an unarmed or deactivated state. The alarm device further has a signal generator.

With the portable article operatively associated with the alarm device at a destination site, which may be at a front doorstep, or an interior location designed for accepting deliveries at which it remains visible or otherwise vulnerable, etc., and the alarm device in the armed state, the signal generator on the alarm device generates an alarm signal in the event an unauthorized activity with respect to the portable article occurs.

The alarm device may be directly connected to the portable article or may be connected through packaging material containing, or overlying, the portable article. The connection may be a permanent connection, a connection as by using adhesive, or a releasable connection, such as alarm assemblies that are separable as by using dedicated tooling or techniques that limit control and operation thereof to authorized individuals.

The alarm device may be a self-contained system at the destination site or one that cooperates with one or more components at the destination site to become operatively associated with the alarm device and cause the alarm device to be placed in its armed state.

For example, there may be a pairing of components, one each on the portable article and at the destination site, that cooperate to cause the portable article to become operatively associated with the alarm device and allow placement of the alarm device in the armed state. The pairing may occur as an incident of a component making up part of the alarm device being placed in proximity to the component of the alarm device at the destination site.

The alarm device may be changed from the unarmed state into the armed state with the portable article residing at the destination site. The action taken to change the state of the alarm device may be performed at the destination site, as by a delivery person, or from a location remote from the destination site. The unauthorized activity that triggers the signal generation may vary significantly. The unauthorized activity may be simply movement of the portable article and thus movement of the alarm device once the alarm device is placed in its armed state. A triggering movement may be any movement or movement of the portable article. Alternatively, the movement may trigger the alarm signal as an incident of the article being moved more than a predetermined length of time away from the destination site. The unauthorized activity may also be removal of the alarm device from the portable article or packaging therefor, as is known.

The signal from the generator may be an audible signal detectable at the detection site—whether audible and/or visual in nature. Alternatively, the signal from the generator may be directed to a device at a remote location. In one form the signal generator may trigger operation of a camera, which might be monitored onsite or at a remote location.

Operation of the alarm device and monitoring thereof can be effected through any type of existing wired or wireless device. For example, the alarm device may be placed in the armed state using a smartphone or tablet. Activation may be effected using Bluetooth, NFC, or any other wireless protocol available or that becomes available. This wired/wireless communication may be used to perform any function associated with the system, including changing states, monitoring states, etc.

In one form, the alarm device additionally has a sleep state which may avoid draining of a power supply for any component of the alarm device during operation. The alarm device is constructed so that the signal generator will generate a signal in the event the unauthorized activity occurs with the alarm device in the sleep state.

The alarm device may be placed into the sleep state through manual control or the sleep state might automatically be transitioned to after passage of a predetermined amount of time after the alarm device is placed into the armed state.

The alarm device in the embodiment illustrated and described herein is a motion sensitive alarm intended to protect a delivered package. If the package is moved without first disarming the alarm device, then the alarm will sound. To provide control of the alarm device to the recipient, a smart device application, or app, will use near field communication (NFC). The smart device apps are also connected to a cloud server to provide necessary association between the alarm device and the package.

The alarm device has three status modes, namely, unassigned/deactivated, assigned, and activated. The alarm device is disarmed and ready to be applied to a package when it is unassigned. The shipper will use an app to read the alarm device ID and write a package ID to the alarm device. This information is copied to a cloud server. The alarm device then transitions to the assigned mode.

In the assigned mode, the alarm device is being delivered to the recipient. The alarm device is also ready to be activated by the delivery driver. The delivery driver will use an app to activate the alarm device after the package is delivered. Once activated by the driver, there is a thirty second placement delay before motion will trigger the alarm. The driver can reactivate to turn the alarm sound off and start another thirty second delay. Once activated, the alarm device transitions to the activated mode.

In the activated mode, the alarm is armed and will sound if the package is moved without the alarm device first being deactivated. The recipient, typically a customer, will use a smart device app to deactivate the alarm device. The alarm device then transitions to the unassigned/deactivated mode. For simplicity herein, the recipient of the package is referred to as a user.

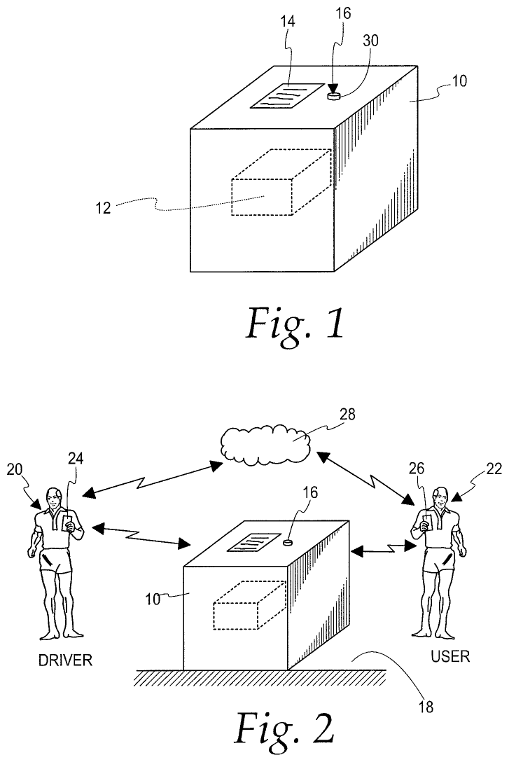

Referring initially to FIG. 1, a package 10, such as a cardboard container, houses a portable article 12. The package 10 includes a shipping label 14 which identifies the recipient of the package 10. Adhered to the package 10 is an alarm device 16 in accordance with the invention. As noted above, the alarm device 16 can be associated with the portable article 12 in any manner. Packaging is not required. An adhesive could be used or some type of fastener to secure a portion of the alarm device 16 to the packaging or the portable article.

Referring also to FIG. 2, the package 10 with the alarm device 16 is shown delivered to the user. If delivery is to a house, then the package 10 is typically placed on a surface such as a porch 18. As will be apparent, the package 10 can be delivered to any location as desired by the user. In accordance with an exemplary delivery event, a driver 20 delivers the package 10 to the location 18 and then activates the alarm device 16. Again, for simplicity herein, the individual activating the alarm device is referred to as a driver, although the invention is not limited to any particular form of delivery. The alarm device 16 is subsequently deactivated by the recipient represented by a user 22. The driver 20 uses a smart device 24, such as a mobile phone or tablet. Likewise, the user 22 uses a smart device 26, such as a mobile phone or tablet. Both smart devices 24 and 26 communicate wirelessly with the alarm device 16 and via the cloud 28 using standard forms of communication, as discussed below.

Communications via the cloud 28 are typically implemented by cell phone communications. Alternatively, communication could be via Wi-Fi or the like and using local area network communications, all of which are known. The invention is not limited to use with any particular type of communication service between the smart devices 24 and 26 and the cloud 28.

In the illustrated embodiment, communication between the smart devices 24 and 26 and the alarm device 16 is advantageously implemented using NFC communications. As is known, NFC is a form of radio frequency identification (RFID) communication. As is apparent, RFID or another form of communication could be used, such as Bluetooth. Both NFC and RFID employ radio signals for tagging and tracking purposes. A typical NFC tag includes an antenna and a memory chip that stores data and a communication device or circuit. RFID often works acceptably at distances of many feet, such as 10 feet, and NFC communications are intended to be in the range of about 3 to 4 centimeters, with 10 cm being the typical maximum. The use of NFC requires the driver 20 and/or the user 22 to place the respective smart device 24 or 26 directly over the alarm device 16. This prevents a potential thief, or porch pirate, from deactivating the alarm device 16 from a remote location prior to attempting to abscond with the package 10.

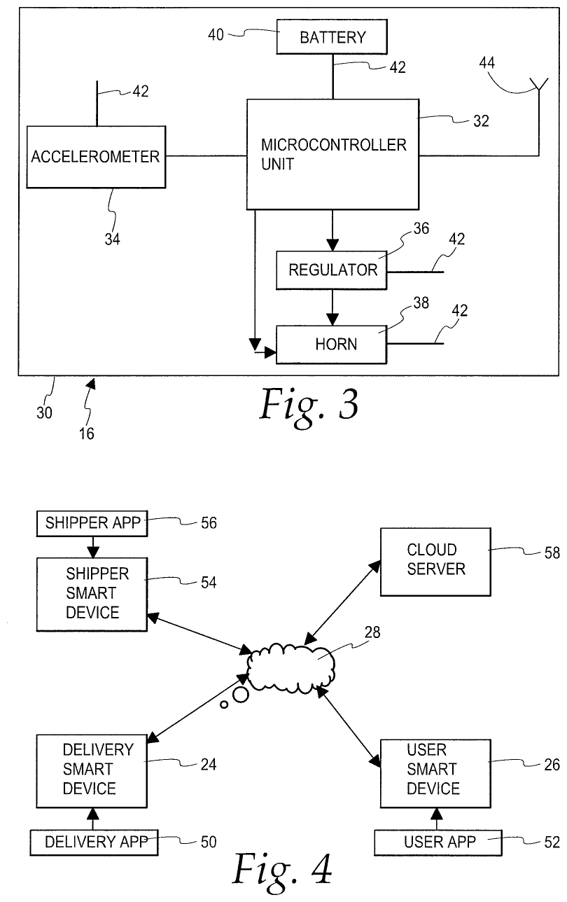

Referring also to FIG. 3, the alarm device 16 includes a housing, represented by the outline 30. The housing 30 in the embodiment shown in FIG. 1 is a disk-shaped housing of a plastic material or the like. As will be apparent, the housing 30 can include any shape as necessary or desired.

The alarm device 16 includes a microcontroller unit (MCU) 32. The MCU 32 in the illustrated embodiment is a type LPC8N04FHI24 MCU integrated circuit chip. The MCU 32 includes an onboard programmed processor and memory and includes integrated NFC and RFID connectivity. The MCU 32 is operatively connected to an accelerometer 34, a regulator 36 and an alarm horn 38. The alarm device 16 is powered by a battery 40 which is connected to each of the other devices via a power line 42. The MCU 32 is also connected to an antenna 44.

The accelerometer 34 may comprise a 3-axis accelerometer such as a type MXC 4005XC integrated circuit chip. The regulator 36 is connected between the MCU 32 and the horn 38. The regulator 36 may comprise a switching boost regulator such as a type MIC2288 chip which steps up the battery voltage from about three volts to twenty-four volts to power the horn 38.

As described above, there are multiple entities involved in the delivery transaction of any particular portable article to a user. The environment in which the typical transaction occurs is illustrated in FIG. 4 which includes the cloud 28 for long range communications. The delivery smart device 24 is programmed to use a delivery app 50. The user smart device 26 includes a user app 52. Additionally, the shipper of the package 10 uses a shipper smart device 54 operating a shipper app 56. A cloud server 58 is shown for communication with the smart devices 24, 26 and 54 via the cloud 28. The shipper smart device 54 may be a smartphone or tablet, or the like, or may be a desktop computer or any other type of device suitable for a commercial environment. The shipper smart device 54 must have capability to communicate in any known manner with the cloud 28 and communicate using NFC communications with the alarm device 16.

The cloud server 58 may take any known form and comprises one or more processing systems and memory devices conventionally programmed for cloud applications, as is well known. The system herein is not dependent on the particular form of the cloud server 58 other than using features as described herein.

As described above, the alarm device 16 has three status modes, namely, unassigned/deactivated, assigned and activated. The alarm device 16 also has two operating modes, namely, a user interface mode and an alarm mode. The user interface mode provides interaction with each of the device apps 50, 52 and 56, as described below.

The shipper app 56 is used during initial setup with the alarm device 16 in the user interface mode. The alarm device 16 initiates communications with the shipper smart device 54, The alarm device 16 transmits its unique NFC ID and the battery level to the shipper smart device 54. The alarm device 16 selectively receives an unlock code from the shipper smart device 54 and sets a lock bit which prevents the reading of the package ID and the NFC ID.

In the user interface mode with the delivery smart device 24, the alarm device 16 responds to commands from the delivery app 50. If the alarm device 16 receives an activation command then the alarm device 16 will initiate a thirty second placement delay, to allow the driver to place the package in the desired location, before generating two horn beeps and entering the activated mode. If the driver wishes to move the package, then the delivery app 50 can send a reset command to deactivate and reactivate after another thirty second placement delay. Thereafter, the alarm device 16 goes to sleep.

In the user interface mode with the user smart device 26, the alarm device 16 initiates communications and transmits the user app 52 to the smart device 26. The user 22 is authenticated through the cloud server 58, as discussed below, and receives an unlock code. If the alarm device 16 receives an unlock code from the user smart device 26, then the alarm device 16 verifies the unlock code and disarms the alarm by transitioning to the deactivated mode and sounding a single horn beep. If an incorrect unlock code is received, then there are four horn beeps generated. If five incorrect codes are received, then the alarm device 16 goes into lock mode for fifteen minutes. Thereafter, the alarm device 16 goes to sleep.

In the activated mode, the alarm device 16 will wake up responsive to a signal that the package 10 has moved as determined by the signal from the accelerometer 34. If so, then the alarm device 16 waits two seconds and rechecks the accelerometer signal and compares it to previous readings. If further movement is detected, then the alarm device 16 enters the alarm mode and generates an audible signal using the horn 38. As is apparent, a visual signal could be provided as an alternative or in addition to the audible signal. If the accelerometer reading is the same, then the alarm device 16 will go back to sleep.

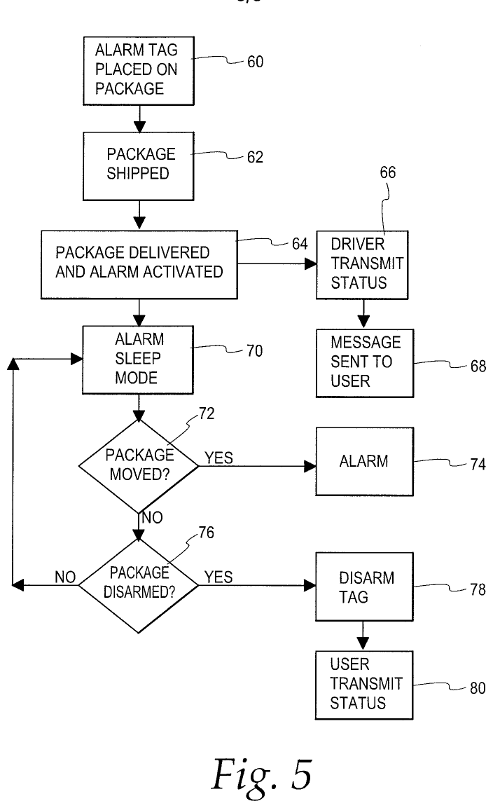

Referring to FIG. 5, a flow diagram illustrates the process for delivery of the package 10 from the shipper location to the customer's desired location 18, see FIG. 2. The process begins after the alarm device 16 is placed on or with the portable article, such as being adhered to the package 10 by the shipper at a block 60. The alarm device 16 is in the unassigned mode. The shipper app 56 is used to read the NFC ID and the battery level from the alarm device 16, The shipper app 56 generates an unlock code. The unlock code may be a combination of the NFC ID and a package ID. The package ID may be the package barcode, an invoice number, or the like. The particular type of package ID used is up to the shipper. The unlock code and an assignment bit are sent to the alarm device 16. Finally, the shipper app 56 sends the NFC ID, the package ID and the unlock code to the cloud server 58. The package 10 is then shipped in any known manner at a block 62.

The package 10 is ultimately delivered to the location 18 by the driver 20 and the delivery app 50 is used to activate the alarm device 16 at a block 64, The delivery app 50 wakes up the alarm device 16 using NFC communications. The delivery app 50 reads the NFC ID from the alarm device 16 and verifies the driver's GPS coordinates. This can be done by knowing the intended location of the delivery of the package and using GPS coordinates of the delivery smart device 24 to confirm that delivery is to the correct location. The delivery app 50 then activates the alarm device 16. The delivery app 50 transmits the delivery time and GPS location of delivery to the cloud server 58 at a block 66. The cloud server 58 then sends a message to the user at a block 68. The message could be by email or text message, or the like, and indicates the package 10 has been delivered. The message could include a photo showing the package 10 at the location 18.

Once the driver completes the delivery by activating the alarm, then the alarm device 16 enters a sleep mode at a block 70. Thereafter, the alarm device 16 will periodically wake up. A decision block 72 determines if the package 10 has moved. The MCU 32 checks the accelerometer reading and compares it to a prior reading to verify movement. If undesired movement is detected, then the alarm device 16 enters into an alarm mode at a block 74 and activates the horn 38.

Particularly, when the alarm device 16 is in the activated mode, then the alarm device 16 will sense for package movement as determined by the accelerometer 34. If the accelerometer 34 detects movement, then the MCU 32 will wake up, if not already awake. The MCO 32 will then recheck the accelerometer reading after a two second delay. If a second movement is detected, then the alarm will sound. This avoids inadvertent activation if the wind or an animal or the like inadvertently moves the package 10 a short distance. The user can disarm the alarm at any time by using the user app 52, discussed below.

Once the user 22 receives the message from the cloud server 58 that the package 10 has been delivered, then the user can download the user app 52 from the alarm device 16, as discussed above, and authenticate to the cloud server 58. This may be done, for example, by signing on to the users account in a conventional manner. The user app 52 obtains the package ID, the NFC ID and the unlock code from the cloud server 58 after authentication. The user 22 then places the user smart device 26 in close proximity to the alarm device 16 at the location 18. As is apparent, this should be done before moving the package 10. The user app 52 reads the NEC ID of the alarm device 16 to verify that it is the correct device. The operation will only work with the correct NEC ID. The user app 52 sends the unlock code to the alarm device 16 to disarm at a block 78 so that the alarm device 16 transitions to the deactivated mode. The user app 52 receives a result status of disarming. The user app 52 transmits the status to the cloud server 58 at a block 80. The status includes the date and time, the NFC ID and the GPS coordinates of the user smart device 26. The status Information may also include the Mac ID of the user smart device 26. The alarm device 16 is then deactivated and goes back to sleep.

The protocol for reading and writing to the alarm device 16 using NFC communications follows conventional standards. The data should be encrypted so that replaying the same transmission will not work. Each transmission is unique. Each transmission also contains a key that identifies it as an alarm device, the unique NFC ID and the data required for the operation being performed, as discussed above. The particular protocol used does not form part of the invention.

Thus, there is described herein the use of a relatively low-cost NFC alarm device 16. Particularly, the alarm device 16 may be used one time and then disposed of. The alarm device 16 is used to verify delivery to the proper location. The alarm device 16 is a smart communication device which communicates short distances using NFC communications. The arming and disarming of the alarm device 16 is via mobile phone, tablet or other smart device. Advantageously, the smart device has GPS capability. This allows the system and method described herein to use GPS data and the Mac ID which is specific to the smart device and which is owned by the user. By using the GPS data at the time of delivery and at the time of deactivation, important information is available from the cloud server 58. This includes how long it took for the package 10 to be delivered, whether or not the delivery location was the same as the deactivation location and the identification of the particular device user smart device that deactivated the alarm device 16. This information could be used by law enforcement to track the person who deactivated the alarm device 16, thus deterring a further aspect of theft.

The present invention may be a system, a method, and/or a computer program product. The computer program product may include a computer readable storage medium (or media) having computer readable program instructions thereon for causing a processor to carry out aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing disclosure of specific embodiments is intended to be illustrative of the broad concepts comprehended by the invention.

1. A method of handling a portable article, the method comprising the steps of:
delivering the portable article to a destination site at which the portable article is operatively associated with an alarm device storing an unlock code,
operatively placing the alarm device into an activated mode,
providing the unlock code to a recipient of the portable article, and
with the portable article operatively associated with the alarm device at the destination site and the alarm device in the activated mode, the alarm device generates an alarm signal in the event an unauthorized activity with respect to the portable article occurs and the alarm device transitioning to a deactivated mode responsive to receiving the unlock code from the recipient of the portable article.

2. The method of handling a portable article according to claim 1 wherein the alarm device comprises a communications controller using wireless communications.

3. The method of handling a portable article according to claim 1 wherein the recipient transmits the unlock code to the alarm device using a smart device having wireless communications.

4. The method of handling a portable article according to claim 1 wherein delivery personal place the alarm device into an activated mode using a smart device having wireless communications.

5. The method of handling a portable article according to claim 1 wherein the wireless communications comprise near field communications.

6. The method of handling a portable article according to claim 1 further comprising the step of a shipper of the portable article associating the alarm device with the portable article and generating the unlock code.

7. The method of handling a portable article according to claim 1 further comprising the step of authenticating the recipient prior to providing the unlock code to the recipient.

8. The method of handling a portable article according to claim 3 wherein the recipient smart device transmits location of the smart device and time of deactivation to a remote location for verifying delivery status of the portable article.

9. An alarm device for monitoring delivery of a portable article to a destination site, comprising:
a housing adapted to be associated with a portable article, the housing enclosing a programmable controller unit configured for wireless communications, a sensor and an alarm generator, and having a unique ID, wherein the programmable controller unit is programmed to: receive and store an unlock code using wireless communications, receive a command to place the alarm device into an activated mode using wireless communications, and with the portable article operatively associated with the alarm device at the destination site and the alarm device in the activated mode, the alarm device activating the alarm generator in the event an unauthorized activity with respect to the portable article occurs as determined by the sensor and the alarm device transitioning to a deactivated mode responsive to receiving the unlock code from the recipient of the portable article using wireless communications.

10. The alarm device according to claim 9 wherein the alarm device uses NFC wireless communications.

11. The alarm device according to claim 9 wherein the alarm device uses RFID wireless communications.

12. The alarm device according to claim 9 wherein the programmed controller unit is programmed to selectively operate in a user interface mode for effecting wireless communication with any one of shipper smart device, a driver smart device or a user smart device.

13. The alarm device according to claim 12 wherein each of the smart device includes a program app for communicating with the alarm device.

14. The alarm device according to claim 9 wherein the sensor comprise an accelerometer and the unauthorized activity comprises movement of the portable article.

15. A system for monitoring delivery of a portable article to a destination site, comprising:
an alarm device adapted to be associated with a portable article, the alarm device including a programmable controller unit configured for wireless communications, a sensor and an alarm generator, and having a unique ID;
a first smart device for generating an unlock code and having wireless communications for transmitting the unlock code to the alarm device;
a second smart device having wireless communications and responsive to delivery of the portable article to a destination site operatively placing the alarm device into an activated mode; and
a third smart device having wireless communications selectively receiving the unlock code,
wherein the programmable controller unit is programmed to; receive and store the unlock code from the first smart device, receive a command to place the alarm device into the activated mode from the second smart device, and with the portable article operatively associated with the alarm device at the destination site and the alarm device in the activated mode, the alarm device activating the alarm generator in the event an unauthorized activity with respect to the portable article occurs as determined by the sensor and the alarm device transitioning to a deactivated mode responsive to receiving the unlock code from the recipient of the portable article using the third smart device.

16. The system according to claim 15 wherein the wireless communications comprise NFC wireless communications.

17. The system according to claim 15 wherein the wireless communications comprise RFID wireless communications.

18. The system according to claim 15 wherein the programmed controller unit is programmed to selectively operate in a user interface mode for effecting wireless communication with any one of the first, second and third smart devices.

19. The system according to claim 18 wherein each of the smart devices includes a program app for communicating with the alarm device.

20. The system according to claim 15 wherein the sensor comprise an accelerometer and the unauthorized activity comprises movement of the portable article.

21. The system according to claim 15 further comprising a cloud server for communicating with each of the smart devices, the cloud server storing status information relative to delivery of the portable article.

22. A method of handling a portable article, the method comprising the steps of:
delivering the portable article to a destination site at which the portable article is operatively associated with an alarm device,
the alarm device having an armed state and an unarmed state,
with the portable article operatively associated with the alarm device at the destination site and the alarm device in the armed state, the alarm device generates an alarm signal in the event an unauthorized activity with respect to the portable article occurs.

23. The method of handling a portable article according to claim 22 wherein the portable article is operatively associated with the alarm device by placing the portable article in proximity to a component of the alarm device at the destination site.

24. The method of handling a portable article according to claim 22 wherein the portable article is operatively associated with the alarm device by attaching at least a part of the alarm device to the portable article.

25. The method of handling a portable article according to claim 22 wherein the portable article is operatively associated with the alarm device by attaching at least a part of the alarm device to packaging material for the portable article.

26. The method of handling a portable article according to claim 22 further comprising the step of changing the alarm device from the unarmed state into the armed state with the portable article at the destination site.

27. The method of handling a portable article according to claim 26 wherein the alarm device is changed from the unarmed state into the armed state through an action at the destination site.

28. The method of handling a portable article according to claim 22 wherein the unauthorized activity is movement of the portable article.

29. The method of handling a portable article according to claim 22 further comprising the step of changing the alarm device from the armed state into the unarmed state with the portable article at the destination site.

30. The method of handling a portable article according to claim 22 wherein the alarm device has a sleep state and further comprising the step of causing the alarm device to change from the armed state into the sleep state at the destination site, whereupon the unauthorized activity causes the alarm device to generate the alarm signal.

31. The method of handling a portable article according to claim 30 wherein the alarm device is changed from the armed state into the sleep state upon passage of a predetermined time period after the alarm device is changed into the armed state.

32. The method of handling a portable article according to claim 22 further comprising the step of monitoring the state of the alarm device through a wirelessly connected device.

33. The method of handling a portable article according to claim 22 further comprising the step of changing the state of the alarm device through a wirelessly connected device.
